(19) United States
(12) Patent Application Publication
(10) Pub. No.: US 2026/0132737 A1
(43) Pub. Date: May 14, 2026

(54) Aircraft Engine

(71) Applicant: Kahle GmbH, Luneburg (DE)

(72) Inventor: Niko Lehmann, Scharnebeck (DE)

(21) Appl. No.: 18/704,403

(22) PCT Filed: Oct. 25, 2022
(86) PCT No.: PCT/DE2022/100794

§ 371 Date: Apr. 24, 2024

(30) Foreign Application Priority Data
Oct. 26, 2021 (DE) 10 2021 127 893.7

(51) Int. Cl. F02C 3/22; F02C 3/30

(52) U.S. Cl. CPC F02C 3/22; F02C 3/30; F05D 2220/323; F05D 2220/768; F05D 2240/35

(57) ABSTRACT

An aircraft engine includes a fuel-cell-based, electrically operated axial-flow fan which, enables optimization of the power-to-weight ratio and can be used as a climate-friendly drive for a civil commercial aircraft. The aircraft engine includes a housing having an inlet and an outlet, an axial-flow fan located next to the inlet in a first housing portion and having at least one rotor, at least one electric motor which is configured to drive the rotor, at least one fuel cell unit configured to supply power to the electric motor, and at least one combustion drive located inside the housing and downstream of the axial-flow fan. The housing is configured with a convergent portion adjoining the first housing portion and a divergent portion adjoining the convergent portion. The combustion drive includes a combustion chamber containing a hydrogen injector located or formed inside the divergent portion.

### TECHNICAL FIELD

The invention relates to an aircraft engine for commercial aircraft.

### PRIOR ART

In civil aviation, there is a need for propulsion systems that are free of environmentally harmful emissions, in particular for CO₂-free propulsion systems. CO₂ In this respect, fuel cell-based drives are known in prior art in which the required thrust is generated via an electrically operated axial-flow fan. For use in commercial aircraft, the practical problem here is that operation is not economical. The capacity required to provide the maximum power needed in the take-off phase leads to a total mass that is too high for economical operation due to the high power-to-weight ratio or mass-to-power ratio of currently available fuel cells. The commercial aircraft would fly, but would not be able to transport a sufficient load.

WO 2018/158767 A1 discloses an aircraft with a hydrogen afterburner and at least one propeller arranged in the longitudinal axis of the aircraft. WO 2018/158767 A1 does not disclose a technical solution for the more detailed technical configuration or the mode of operation of the propellers. For accommodating the afterburner, WO 2018/158767 A1 discloses the arrangement in a convergently shaped housing, i.e. one that narrows in the direction of flow.

EP 2 878 795 A1 discloses an engine for actuating an aircraft having a housing with an inlet and an outlet, a fan arranged therein, which is driven by an electric motor that can be coupled to a fuel cell arrangement, wherein the engine can have an additional combustion engine. EP 2 878 795 A1 does not disclose any technical solutions for the physical design of the housing or the more detailed technical nature and arrangement of the combustion engine.

### DISCLOSURE OF THE INVENTION

The invention is based on the problem of providing an aircraft engine having a fuel-cell-based, electrically operated axial-flow fan, the type and design of which enables optimization of the power to weight ratio and can be used as a climate-friendly drive for a civil commercial aircraft.

The problem is solved according to the invention by an aircraft engine according to claim 1. Advantageous embodiments of the invention can be found in the dependent claims.

The core of the invention is an aircraft engine, having: a housing having an inlet and an outlet; an axial-flow fan which is located next to the inlet in a first housing portion and has at least one rotor; at least one electric motor which is designed to drive the rotor; at least one fuel cell unit which is designed to supply power to the electric motor; and at least one combustion drive located inside the housing and downstream of the axial-flow fan, wherein the housing is designed with a convergent portion adjoining the first housing portion and a divergent portion adjoining the convergent portion and wherein the combustion drive comprises a combustion chamber containing a hydrogen injector, which are located or formed within the divergent portion. For the purposes of the invention, downstream means arranged downstream in the direction of flow from the inlet to the outlet. For the purposes of the invention, convergent means narrowing in the direction of flow, divergent means widening in the direction of flow. The aircraft engine according to the invention has the advantage that the total mass and thus also the power-to-weight ratio can be easily optimized due to the combination of an electrically operated axial-flow fan supplied by at least one fuel cell unit with a combustion drive that can be used as a hydrogen afterburner. The power design of the at least one fuel cell unit and the axial-flow fan is optimized in terms of mass for normal flight operation, while the maximum power required in the take-off phase is achieved by switching on the hydrogen afterburner. The arrangement of the two drives is also highly spatially integrated due to the physical configuration in a common housing and optimized in terms of flow guidance and thrust generation. The integration of a hydrogen-based combustion drive is also system-efficient due to the presence of hydrogen, which is required anyway due to the fuel cell-based drive. The storage, provision and supply of a separate combustion fuel are unnecessary.

The electric drive is integrated efficiently and with a high efficiency by comprising coil means arranged circumferentially of the rotor on or in the housing and permanent magnet means formed by the rotor blades or formed or arranged in a circumferential end portion of the rotor blades or formed or arranged in an outer ring surrounding the rotor blades. In this configuration, the rotor acts as an internally rotating rotor. The electric drive is realized as a low-friction brushless electric motor, as there is no conductive electrical contact between the rotor and stator, but a magnetic bearing.

To optimize the efficiency of the axial-flow fan, a second, counter-rotating rotor is arranged downstream of the at least one rotor. The principle of counter-rotation allows the implementation of a high power density in a compact design.

To optimize the air flow and thrust effect, a guide wheel is arranged downstream of the at least one rotor or the counter-rotating pair of rotors. The air flow exiting the rotor with a swirl due to its rotation is deflected into a laminar air flow with a particularly high thrust effect by the guide vanes of the fixed guide wheel arranged downstream.

If the axial-flow fan is designed with multiple rotors to increase the thrust force, these are designed as several rotor/guide wheel combinations arranged in series within the first housing portion or combinations of counter-rotating rotors with or without a downstream guide wheel to optimize the flow path and the thrust effect and/or to optimize the efficiency.

To ensure operation at higher altitudes, at least one compressor integrated into the housing or designed as an external component and interacting with the aircraft engine is provided, with which air is supplied to the at least one fuel cell unit at a higher pressure than the ambient pressure. This ensures proper operation of the fuel cells even at higher altitudes from around 3000 meters, where the ambient pressure is significantly reduced. This configuration also enables a general improvement in the efficiency of the at least one fuel cell unit, regardless of the altitude, by supplying the fuel cells with air at a defined pressure that is higher than the ambient pressure. As an external compressor, for example, it is arranged in a wing or the tail unit to save space.

In a structurally integrated and compact configuration of the aircraft engine, the compressor is formed as an axial end portion of an existing rotor or by a separate rotor arranged in the first housing portion. The pressure is increased by diverting the compressed air flow generated by the rotor blades of the compressor to the fuel cells via a corresponding duct.

To improve efficiency, the guide wheel is installed downstream of the compressor, which is designed as a component through which liquid hydrogen flows. At −252.9° C., hydrogen has a very low boiling point. The component through which liquid hydrogen flows therefore offers the compressed air a heat sink, whereby the heat energy generated during compression is dissipated again and isothermal compression is achieved in the balance.

To further improve the efficiency of the at least one fuel cell unit, at least one valve device is also provided, with which hydrogen is also supplied to the at least one fuel cell unit at a higher pressure than the ambient pressure. Preferably, the hydrogen is stored at a pressure level of, for example, 6 bar, which is sufficiently higher than the ambient pressure, thus ensuring a sufficient pressure level in the overall system. In other forms of storage, the hydrogen can be compressed by a compressor before being fed to the at least one fuel cell unit, before the hydrogen is fed at a defined overpressure under valve control.

Tests have shown that the optimum efficiency of modern fuel cells with a closed cathode available on the market is achieved with a charge of 2 bar, at which the fuel cells develop a current density of up to 2 A/cm² or more. To optimize efficiency, the compressor and the valve device are therefore preferably designed such that the air and hydrogen are each supplied to the at least one fuel cell unit at a pressure of 2 bar.

To further improve the efficiency of the fuel cell device, at least one compressor integrated into the housing or designed as an external component and interacting with the aircraft engine is also provided, in which outside air is passed over or through components through which liquid hydrogen flows and the resulting condensate is mixed with the air supplied to the fuel cell device. At −252.9° C., hydrogen has a lower boiling point than oxygen (−183° C.), so that the oxygen contained in the air flow at least partially condenses when flowing around the components through which liquid hydrogen flows, i.e. it changes from a gaseous to a liquid state. By adding the condensate, a higher oxygen saturation of the air supplied to the fuel cell device is achieved with an increased oxygen content of, for example, 40% instead of 21%, which is available for the oxidation reaction in the fuel cell device.

To increase the power density, the at least one fuel cell unit is formed from multiple flat fuel cell layers (also referred to as a “stack”) arranged on top of each other and connected to each other as a stack.

In a structurally highly integrated and highly compact configuration of the aircraft engine, the at least one fuel cell unit has an annular or circular cross-section and one or more such fuel cell units is or are arranged circumferentially on the housing. This embodiment also has improved heat management due to its design and physical construction, because the heat generated in the fuel cell unit(s) during operation in normal flight mode (i.e. when the afterburner is inactive) is at least partially dissipated by convection via the housing and the air flow within the housing into the atmosphere surrounding the aircraft engine.

An additional improvement in the mass balance of the aircraft engine is achieved by arranging a device for injecting the water produced during operation of the at least one fuel cell unit in the area of the transition from the convergent to the divergent portion. Each fuel cell is a galvanic cell that converts the chemical reaction energy of the hydrogen continuously supplied as fuel and the oxygen supplied as oxidizing agent into electrical energy, which is used in the aircraft engine according to the invention to operate the electric motor. The chemical reaction according to the reaction equation 2 H₂+O₂→2 H₂O produces water during operation. As the combustion product water is also continuously released into the atmosphere surrounding the aircraft engine during operation, the aircraft becomes constantly lighter during flight. This is done particularly effectively by injecting in the area of the transition from the convergent to the divergent portion of the housing, as the fluid flow expands immediately.

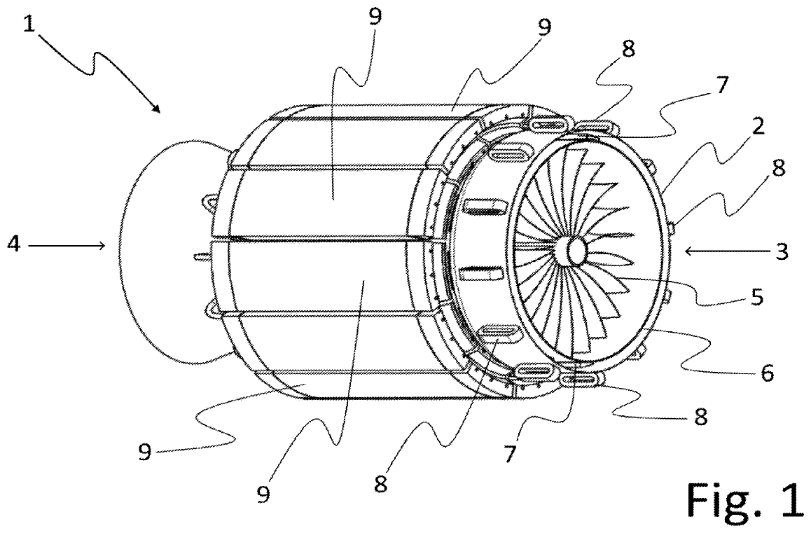

Further advantages of the invention are in shown in detail below together with the description of the preferred exemplary embodiment of the invention with reference to the figures. Shown are:
FIG. 1 a schematic perspective view of an aircraft engine.

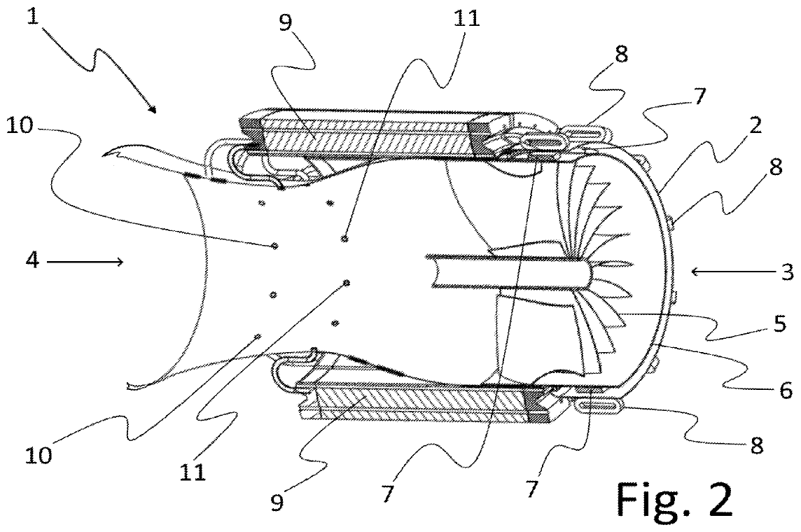

FIG. 2 a schematic perspective sectional view of the aircraft engine according to FIG. 1.

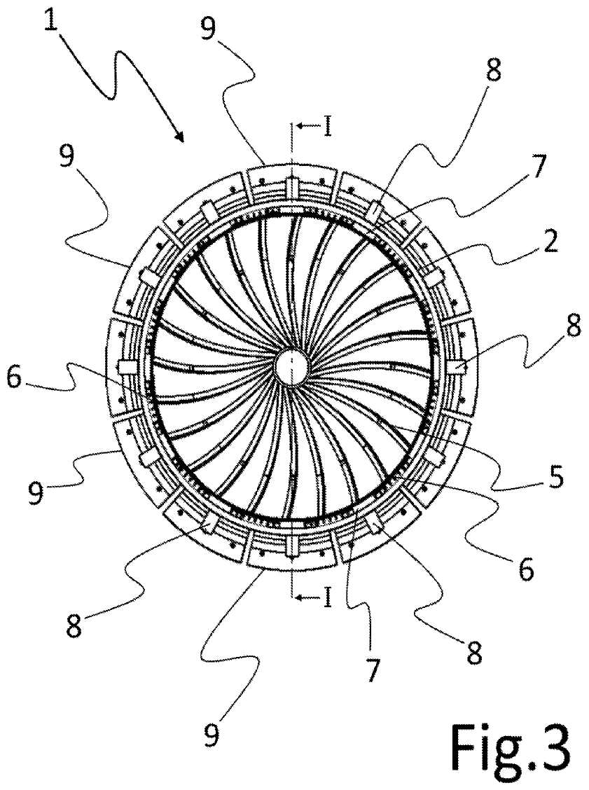

FIG. 3 a frontal view of the aircraft engine according to FIG. 1.

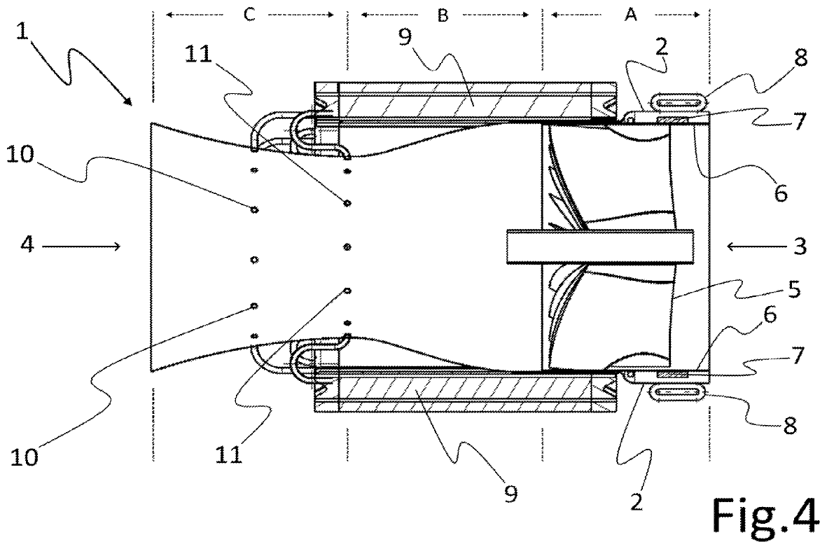

FIG. 4 a schematic longitudinal sectional view of the aircraft drive mechanism along line I-I according to FIG. 3.

FIGS. 1 to 4 show the aircraft engine 1 in different views. FIG. 1 shows the aircraft engine 1 in a schematic perspective view. FIG. 2 shows the aircraft engine 1 in the same perspective as a schematic sectional view. FIG. 3 shows the 1 shows the aircraft engine 1 in a schematic front view. FIG. 4 shows the 1 shows the aircraft engine 1 in a schematic longitudinal sectional view along line I-I as shown in FIG. 3.

The aircraft engine 1 comprises a housing 2 with an inlet 3 and an outlet 4, the axial housing portions A to C of which are shown in the longitudinal sectional view in FIG. 4. A rotor 5 forming an axial-flow fan is arranged in the first housing portion A on the inlet side. The rotor 5 forms a hub in its center, which is guided on a concentrically arranged, static component or component composite, for example an axle or a pivot, for rotatable mounting. Such components are not shown in the illustrations in FIGS. 1 to 4 for the sake of clarity. Such bearing parts can be mounted in the housing 2, for example, by means of struts extending in the peripheral direction towards the inner surface of the housing 2 and connected to it. An alternative bearing can, for example, be provided by an axle or a journal extending from a static guide wheel downstream of the rotor 5 (such a design is not shown in the illustrations in FIGS. 1 to 4). The blade ends of the rotor 5 are surrounded by and connected to a tube-shaped outer ring 6. Multiple permanent magnets 7 are arranged around the outside of the outer ring 6, of which only some of the visible permanent magnets 7 are numbered as examples in the illustrations in FIGS. 2 to 4 for reasons of presentation. Preferably, the permanent magnets are designed as neodymium magnets, which have a high energy density and therefore an advantageous mass/energy ratio. Also in the first housing portion A, multiple coil means 8 are arranged around the housing 2, of which only some of the visible coil means are shown as examples in the illustrations in FIGS. 1 to 4 for reasons of presentation. Together with the outer ring 6, the permanent magnets 7 and the coil means 8, the rotor 5 forms an electric motor, which is designed as a contactless DC motor (=brushless DC motor or BLDC). Together with the outer ring 6 and the permanent magnets 7, the rotor 5 forms the rotor of the electric motor, which is designed as an internal rotor. The coil means 8 arranged circumferentially in the housing portion A on the housing 2 together form the stator of the electric motor. The electric motor can be controlled either digitally using a programmable logic controller (PLC) or electromechanically by controlling the coil means 8 via inductive or optical sensors, for example. An electromechanical control can provide greater robustness depending on the desired application.

To power the electric motor, the aircraft engine 1 comprises multiple fuel cell units 9, which are circular in cross-section and arranged around the circumference of the housing 2. In the illustrations in FIGS. 1 to 4, only individual fuel cell units 9 are shown by way of example for reasons of presentation. Each of the fuel cell units 9 is formed as a stack by a plurality of flat fuel cell layers arranged one above the other and connected to each other (also referred to as a “stack”).

The housing 2 further comprises a second, convergently shaped housing portion B adjoining the first housing portion A and a further third, divergently shaped housing portion C adjoining the housing portion B. A combustion drive, which comprises a combustion chamber and a hydrogen injector, is arranged in the third, divergently shaped housing portion C. The combustion chamber is formed in the divergent housing portion C by the housing jacket. The hydrogen injector is formed by the injector ports 10 for the injection of hydrogen, which are arranged in an annular shape in the divergently shaped housing portion C. In the illustrations in FIGS. 2 and 4, only individual injector ports are shown by way of example for reasons of illustration. Depending on the density and pressure conditions in the specific application context, the combustion process is initiated either as a self-ignition process or by means of a separate ignition device (not shown in the illustrations in FIG. 1 to FIG. 4).

Furthermore, in the transition area from the convergently shaped housing portion B to the divergently shaped housing portion C, annularly arranged outlet openings 11 are provided for the discharge of water, of which only individual outlet openings are numbered by way of example for reasons of illustration. The outlet openings 11 are used to discharge water produced during operation of at least the fuel cell units 9 into the air flow of the aircraft engine 1. The combustion product water produced in the fuel cell units 9 during operation is continuously released into the atmosphere surrounding the aircraft engine by being released into the air flow during operation, as a result of which the aircraft becomes constantly lighter during the flight. Hydrogen present in the aircraft's tanks is consumed as fuel, while the water produced as a reaction product in the fuel cell units 9 is disposed of. Disposal is particularly effective if the discharge takes place in the area of the transition from the convergent to the divergent portion of the housing, as the fluid flow expands immediately here. A further improvement in the mass balance is achieved in this context by additionally using some of the water produced as a combustion product during operation of the fuel cell units 9 as service water during the flight. The water produced in the fuel cell units 9 is pumped into the service water tanks of the aircraft during operation (not shown in the illustrations in FIG. 1 to FIG. 4).

During operation of the aircraft engine 1, the combustion drive is only switched on and used during the take-off phase of the aircraft in addition to the operation of the axial-flow fan as an additional afterburner in order to generate the total thrust required for the take-off of the aircraft. Once the desired cruising altitude has been reached, the combustion drive is switched off and the thrust required for cruising at an essentially constant altitude is generated solely by the operation of the axial-flow fan. This mode of operation offers the advantage of being able to optimize the power of the axial-flow fan and the fuel cell units 9 in relation to mass for normal flight operation, as the maximum power required during the take-off phase is generated by switching on the hydrogen afterburner. The arrangement of the two drivers in the common housing 2 is also spatially highly integrated due to the physical configuration and optimized in terms of flow guidance and thrust generation. The integration of a hydrogen-based combustion drive as an afterburner is also system-efficient due to the presence of hydrogen, which is required anyway for the fuel cell-based power supply of the electric axial-flow fan. The storage, provision and supply of a separate combustion fuel for the afterburner, which is only used in the take-off phase, is not necessary.

The hydrogen required to operate the fuel cell units 9 is stored in a suitable manner in appropriate tanks. Preferably, storage takes place cryogenically in liquid form under a pressure that is simultaneously higher than the external pressure depending on the application environment, for example a pressure of 6 bar.

### LIST OF REFERENCE NUMBERS

A, B, C Housing portions
1 Aircraft engine
2 Housing
3 Inlet
4 Outlet
5 Rotor
6 Outer ring
7 Permanent magnet
8 Coil means
9 Fuel cell unit
10 Injector port
11 Outlet opening

1. An aircraft engine, comprising:
a housing with an inlet and an outlet;
an axial-flow fan located next to the inlet in a first housing portion of the housing, the axial-flow fan having at least one rotor;
at least one electric motor configured to drive the at least one rotor;
at least one fuel cell unit configured to supply power to the at least one electric motor; and
at least one combustion drive located inside the housing and downstream of the axial-flow fan,
wherein the housing defines a convergent portion adjoining the first housing portion and a divergent portion adjoining the convergent portion, and
wherein the combustion drive comprises a combustion chamber containing a hydrogen injector located or formed inside the divergent portion.

2. The aircraft engine according to claim 1, wherein the at least one electric motor comprises (i) a coil arranged around a circumference of the at least one rotor on or in the housing, and (ii) a permanent magnet formed by rotor blades of the at least one rotor or formed or arranged in a circumferential end portion of the rotor blades or formed or arranged in an outer ring surrounding the rotor blades.

3. The aircraft engine according to claim 1, further comprising:
counter rotating rotor arranged downstream of the at least one rotor.

4. The aircraft engine according to claim 3, further comprising:
a guide wheel arranged (i) downstream of the at least one rotor, or (ii) downstream of the at least one rotor and the counter-rotating rotor.

5. The aircraft engine according to claim 3, wherein multiple rotor/guide wheel combinations or combinations of counter-rotating rotors rotating with or without a downstream guide wheel are arranged in series within the first housing portion.

6. The aircraft engine according to claim 1, further comprising:
at least one compressor integrated into the housing or configured as an external component and configured to supply air to the at least one fuel cell unit at a pressure which is higher than an ambient pressure.

7. The aircraft engine according to claim 6, wherein the at least one compressor is formed as an axial end portion of an existing rotor or by a separate rotor arranged in the first housing portion.

8. The aircraft engine according to claim 7, further comprising:
a guide wheel configured as a component through which liquid hydrogen flows, the guide wheel arranged downstream of the at least one compressor, and the guide wheel configured as a further rotor.

9. The aircraft engine according to claim 6, further comprising:
at least one valve device configured to supply hydrogen to the at least one fuel cell unit at a pressure which is higher than an ambient pressure.

10. The aircraft engine according to claim 9, wherein the at least one compressor and the valve device are configured such that the at least one fuel cell unit is supplied with air at a pressure of 2 bar and hydrogen at a pressure of 2 bar.

11. The aircraft engine according to claim 1, further comprising:
at least one compressor integrated into the housing or configured as an external component,
wherein outside air is passed over or through one or more components of the at least one compressor through which liquid hydrogen flows and a condensate that is produced according to in this process is mixed with air supplied to the fuel cell device.

12. The aircraft engine according to claim 1, wherein the at least one fuel cell unit is formed from a plurality of flat fuel cell layers arranged one above the other and connected to each other as a stack.

13. The aircraft engine according to claim 12, wherein the at least one fuel cell unit is annular or circular in cross-section and one or more of the at least one fuel cell units is or are arranged circumferentially on the housing.

14. The aircraft engine according to claim 1, further comprising:
a device configured to inject water produced during operation of the at least one fuel cell unit and arranged in a region of transition from the convergent portion to the divergent portion.
